(19) United States
(12) Patent Application Publication
(10) Pub. No.: US 2015/0134828 A1
(43) Pub. Date: May 14, 2015

(54) INFRASTRUCTURE MIGRATION TOOL

(71) Applicant: EMPIRE TECHNOLOGY DEVELOPMENT LLC, WILMINGTON, DE (US)

(72) Inventor: Ramanathan Ramanathan, Bellevue, WA (US)

(21) Appl. No.: 14/370,184

(22) PCT Filed: Sep. 27, 2013
(86) PCT No.: PCT/US13/62101

§ 371 Date: Jul. 1, 2014

(51) Int. Cl. H04L 12/911; G06F 17/30

(52) U.S. Cl. CPC H04L 47/821; G06F 17/303
USPC 709/226

(57) ABSTRACT

Technologies are generally described for systems, devices and methods effective to facilitate a migration of data between computing infrastructures. In some examples, a data migration unit may identify first pieces of data with a first service requirement and second pieces of data with a second service requirement. The data migration unit may associate the first pieces of data with each other to form a first virtual data core and the second pieces of data with each other to form a second virtual data core. The data migration unit may assign a first set of parameters to the first virtual data core and a second set of parameters to the second virtual data core. The set of parameters may include a model of the pieces of data, an operating environment of the pieces of data, and instructions that facilitate the migration.

### BACKGROUND

Unless otherwise indicated herein, the materials described in this section are not prior art to the claims in this application and are not admitted to be prior art by inclusion in this section.

Two or more computing devices may be connected together through a communication network. Tasks may be distributed among different computing devices within such a network. Various service level guarantees may be associated with the provision of computing services by the network. A distributed computing network may be more flexible and/or faster than traditional computing network. Distributed computing networks are sometimes referred to as “cloud computing” environments.

### SUMMARY

In one example, a method for facilitating a migration of data from a first computing infrastructure to a second computing infrastructure is generally described. The first computing infrastructure and the second computing infrastructure may be different. The method may include, by a data migration unit, identifying, in the first computing infrastructure, first pieces of data with a first service requirement. The method may further include, associating the first pieces of data with each other to form a first virtual data core. The method may further include, identifying, in the first computing infrastructure, second pieces of data with a second service requirement different from the first service requirement. The method may further include associating the second pieces of data with each other to form a second virtual data core. The method may further include, assigning a first set of parameters to the first virtual data core. The first set of parameters may include a first model of the first pieces of data, a first operating environment of the first pieces of data, and first instructions that facilitate the migration. The method may further include assigning a second set of parameters to the second virtual data core. The second set of parameters may include a second model of the second pieces of data, a second operating environment of the second pieces of data, and second instructions that facilitate the migration. The first set of parameters may be different from the second set of parameters.

In one example, a data migration unit configured to facilitate the migration of data from a first computing infrastructure to a second computing infrastructure is generally described. The first computing infrastructure and the second computing infrastructure may be different. The data migration unit may include a memory and a processor. The processor may be configured to be in communication with the memory. The processor may be configured to identify, in the first computing infrastructure, first pieces of data with a first service requirement. The processor may be further configured to associate the first pieces of data with each other to form a first virtual data core. The processor may be further configured to identify, in the first computing infrastructure, second pieces of data with a second service requirement different from the first service requirement. The processor may be further configured to associate the second pieces of data with each other to form a second virtual data core. The processor may be further configured to store the first and second virtual data cores in the memory. The processor may be further configured to assign a first set of parameters to the first virtual data core. The first set of parameters may include a first model of the first piece of data, a first operating environment of the first piece of data, and first instructions that facilitate the migration. The processor may be further configured to store the first set of parameters in the memory assigned to the first virtual data core. The processor may be further configured to assign a second set of parameters to the second virtual data core. The second set of parameters may include a second model of the second piece of data, a second operating environment of the second piece of data, and second instructions that facilitate the migration. The processor may be further configured to store the second set of parameters in the memory assigned to the second virtual data core. The first set of parameters may be different from the second set of parameters.

In one example, a non-transitory computer readable medium effective to facilitate a migration of data from a first computing infrastructure to a second computing infrastructure is generally described. The first computing infrastructure and the second computing infrastructure may be different. The computer readable medium may include a first virtual data core. The first virtual data core may include first pointers to first pieces of data with a first service requirement. The first virtual data core may be assigned a first set of parameters. The first set of parameters may include a first model of the first pieces of data, a first operating environment of the first pieces of data, and first instructions that facilitate the migration. The computer readable medium may further include a second virtual data core. The second virtual data core may include second pointers to second pieces of data with a second service requirement. The second virtual data core may be assigned a second set of parameters. The second set of parameters may include a second model of the second pieces of data, a second operating environment of the second pieces of data, and second instructions that facilitate the migration. The first set of parameters may be different from the second set of parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example system that can be utilized to implement an infrastructure migration tool;

FIG. 2 depicts the example system of FIG. 1, with additional details relating to data parameters of virtual data cores;

FIG. 3 depicts the example system of FIG. 1, illustrating additional details related to virtual data machines;

FIG. 4 depicts a flow diagram for an example process for implementing an infrastructure migration tool;

FIG. 5 illustrates an example computer program product that can be utilized to implement an infrastructure migration tool; and

FIG. 6 is a block diagram illustrating an example computing device that is arranged to implement an infrastructure migration tool; all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the drawings, can be arranged, substituted, combined, separated, and designed in a wide variety of different configurations, all of which are explicitly contemplated herein.

This disclosure is generally drawn to, inter alia, methods, apparatus, systems, devices, and computer program products related to an infrastructure migration tool.

Briefly stated, technologies are generally described for systems, devices and methods effective to facilitate a migration of data between computing infrastructures. In some examples, a data migration unit may identify first pieces of data with a first service requirement and second pieces of data with a second service requirement. The data migration unit may associate the first pieces of data with each other to form a first virtual data core and the second pieces of data with each other to form a second virtual data core. The data migration unit may assign a first set of parameters to the first virtual data core and a second set of parameters to the second virtual data core. The set of parameters may include a model of the pieces of data, an operating environment of the pieces of data, and instructions that facilitate the migration.

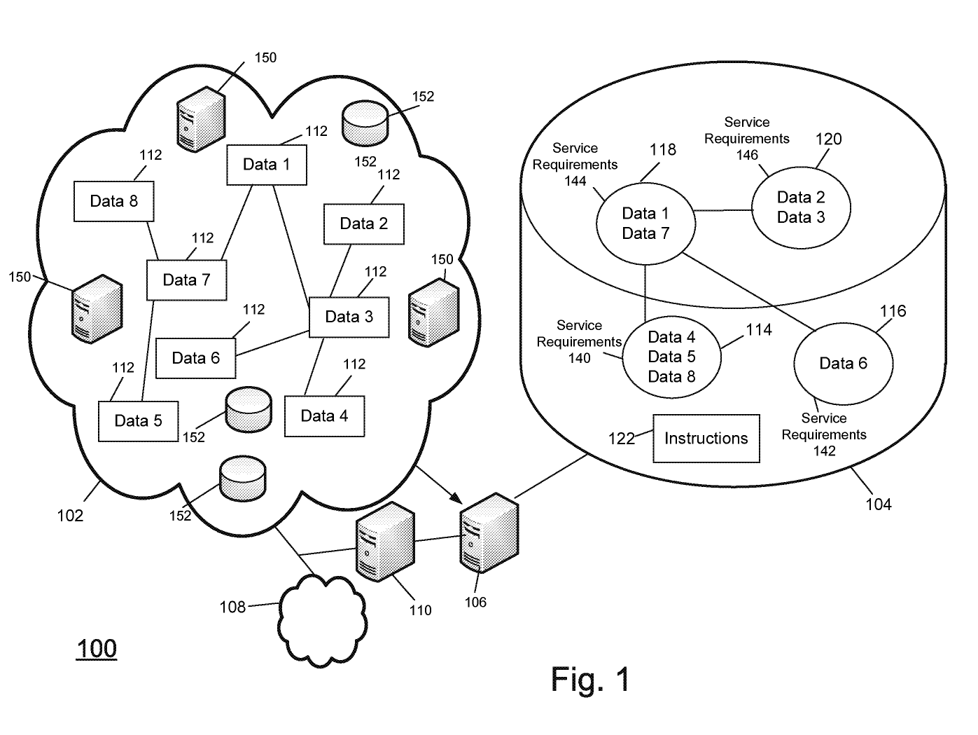

FIG. 1 illustrates an example system that can be utilized to implement an infrastructure migration tool, arranged in accordance with at least some embodiments described herein. As depicted, an example system 100 may include a source infrastructure 102. Source infrastructure 102 may be a distributed computing environment made up of two or more computing devices 150 and two or more memories 152 arranged to be in communication with each other. In an example, source infrastructure 102 may be a “cloud computing” environment. In a further example, computing resources of source infrastructure 102 may be allocated based on demand. For example, during periods of peak activity, a user of source infrastructure 102 may require increased processing power. Accordingly, additional access to processor cores within source infrastructure 102 may be allocated to the user during such periods. Source infrastructure 102 may include one or more memories that store data 112 (including, for example, pieces of data: “Data 1”, “Data 2”, “Data 3”, “Data 4”, “Data 5”, “Data 6”, “Data 7”, and “Data 8”). Data 112 may be any information stored by memories associated with source infrastructure 102. Data 112 may be deployed in a manner consistent with the performance of one or more applications or services provided by source infrastructure 102. Data 112 may include, for example, tables, databases, files and other data structures stored in memories associated with source infrastructure 102.

System 100 may include a target infrastructure 108. Target infrastructure 108 may be a distributed computing environment made up of two or more connected computing devices and two or more memories arranged to be in communication with each other. Target infrastructure 108 may be a different infrastructure than source infrastructure 102. Computing resources of target infrastructure 108 may be allocated based on demand. A user of system 100 may wish to migrate data 112 from source infrastructure 102 to target infrastructure 108. As will be described in further detail below, a data migration unit 106 may be configured to facilitate the migration of data 112 from source infrastructure 102 to target infrastructure 108. Data migration unit 106 may be a computing device including a processor. Data migration unit 106 may include, or may be associated with, a memory 104. Memory 104 may be a local memory or may represent a distributed storage schema. Memory 104 may include instructions 122. Instructions 122 may facilitate the migration of data 112 from source infrastructure 102 to target infrastructure 108. Data migration unit 106 may be configured to receive information about data 112 from source infrastructure 102. Based on received information from source infrastructure 102, data migration unit 106 may associate at least some pieces of data 112 with each other to form one or more virtual data cores 114, 116, 118 and 120. Virtual data cores 114, 116, 118 and 120 may be data structures stored in memory 104. In an example, virtual data cores 114, 116, 118 and 120 may include pointers to pieces of data 112 stored in source infrastructure 102.

Virtual data cores 114, 116, 118 and 120 may reflect an association of one or more pieces of source data 112 with the same or similar service requirements 140, 142, 144 and 146. For example, a first user of a first application of infrastructure 102 may require that piece “Data 2” of data 112 be configured in such a way as to handle at least 350 reads per second. Similarly, a second user of a second application of source infrastructure 102 may require that piece “Data 3” of data 112 be configured in such a way as to handle at least 350 reads per second. In the example, pieces “Data 2” and “Data 3” of data 112 share the same reads per second requirement (i.e., the same service requirement 146). Data migration unit 106 may identify “Data 2” and “Data 3” as having the same or similar service requirements. Data migration unit 106 may identify a connection between “Data 2” and “Data 3.”

Examples of connections between “Data 2” and “Data 3” may include two records in a table with a common relationship via the table. In another example, “Data 2” and “Data 3” may be two tables in a database. The database may provide a basis for the two tables to connect and work together. In another example, “Data 2” and “Data 3” may be two independent databases in a software architecture. In another example, “Data 2” and “Data 3” may be two data elements in a computer memory. “Data 2” and “Data 3” may be configured to exchange information via an internal software architecture. In yet another example, “Data 2” and “Data 3” may be data elements in two independent software modules. “Data 2” and “Data 3” may be configured to exchange information via XML (Extensible Markup Language) protocol. Similarly, “Data 2” and “Data 3” may be two websites or web modules. The websites or web modules may be configured to exchange information via SOAP (Simple Object Access Protocol), XML or other service oriented protocols. In another example, “Data 2” and “Data 3” may be two files in a folder. In another example, “Data 2” and “Data 3” may be two database files connected via SQL (Structured Query Language) connect.

Accordingly, data migration unit 106 may associate piece “Data 2” and piece “Data 3” of data 112 to facilitate migration of data 112 from source infrastructure 102 to target infrastructure 108. The association of “Data 2” and “Data 3” may be stored in memory 104 as virtual data core 120. In an example, pointers to pieces “Data 2” and “Data 3” of data 112 may be stored as virtual data core 120.

In a similar manner, data migration unit 106 may store virtual data cores 114, 116, 118 and 120 for all, or for a portion, of data 112 in memory 104. Other example service requirements may include levels of security, application availability, login performance, reliability of service, functionality, access control, manageability, etc.

Data migration unit 106 may facilitate migration of data 112 by instructing computing devices of source infrastructure 102 to migrate data 112 based on virtual data cores 114, 116, 118 and 120. In another example, data migration unit 106 may facilitate migration of data 112 based on virtual data cores 114, 116, 118 and 120 through one or more intermediary computing devices 110. Intermediary computing device 110 may be a computing device configured to migrate data from source infrastructure 102 to target infrastructure 108. Intermediary computing device 110 may, based on instructions from data migration unit 106, migrate data 112 based on virtual data cores 114, 116, 118 and 120.

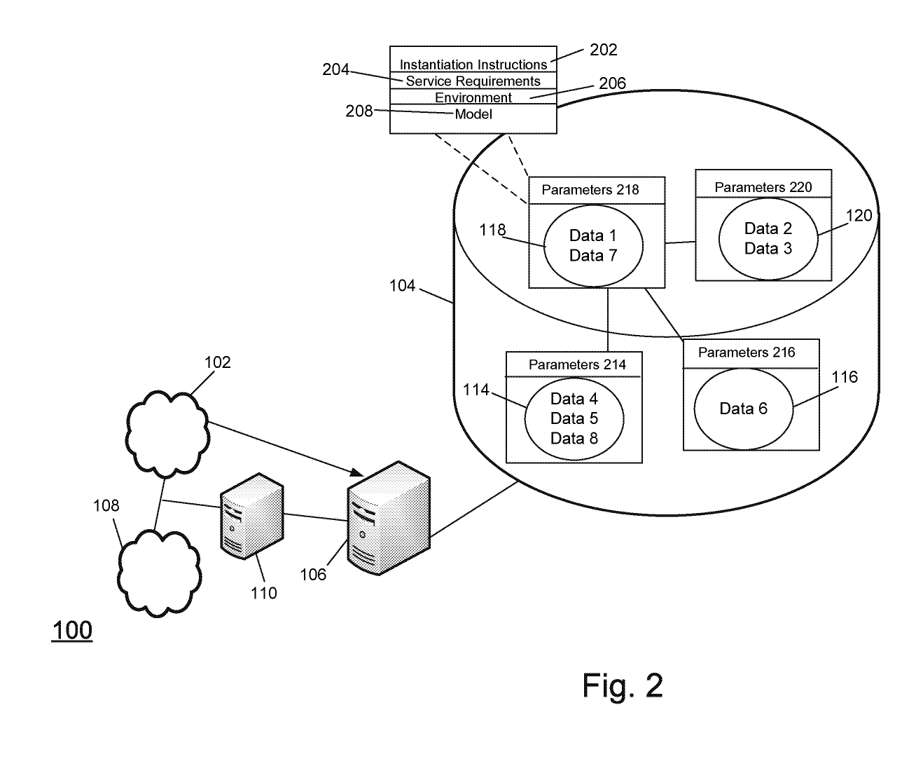

FIG. 2 depicts example system 100 of FIG. 1 with additional details relating to data parameters of virtual data cores, arranged in accordance with at least some embodiments described herein. Those components in FIG. 2 that are labeled identically to components of FIG. 1 will not be described again for the purposes of clarity and brevity.

As previously described with reference to FIG. 1, data migration unit 106 may associate at least some pieces of data 112 with each other to form one or more virtual data cores, including virtual data cores 114, 116, 118 and 120. Data migration unit 106 may assign parameters 214, 216, 218 and 220 to respective virtual data cores 114, 116, 118 and 120. Parameters 214, 216, 218 and 220 may include instructions and requirements for migrating data represented by virtual data cores 114, 116, 118 and 120 to target infrastructure 108. For example, parameters 218 may include one or more of instantiation instructions 202, service requirements 204, environment 206 and/or model 208.

Model 208 may represent the data associated in virtual data core 118. For example, the model may be XML (Extensible Markup Language), JSON (JavaScript Object Notation), SQL (Structured Query Language) or other database schema, memory structure, and/or other applicable format effective to represent data associated in virtual data core 118. Model 208 may be assigned to virtual data core 118 and may be stored in memory 104. An example pseudo code for a model is shown below:

Example of a model: (A SQL table)

```
CREATE TABLE event_code
(
  code character varying(5) NOT NULL,
  description character varying NOT NULL,
  date_created timestamp with time zone NOT NULL DEFAULT now( ),
  date_modified timestamp with time zone NOT NULL DEFAULT
now( ),
  CONSTRAINT maintenance_event_code_pkey PRIMARY KEY (code )
)
WITH (
  OIDS=FALSE
);
ALTER TABLE event_code
  OWNER TO postgres;
CREATE TRIGGER aaa_event_code_stamp
  BEFORE UPDATE
  ON event_code
  FOR EACH ROW
  EXECUTE PROCEDURE row_timestamps( );
```

Environment 206 may include configuration information and instructions concerning both source infrastructure 102 and target infrastructure 108. For example, environment 206 may specify software and/or hardware required in target infrastructure 108 in order to successfully migrate data identified by virtual data cores 114, 116, 118 and 120. The specified software and/or hardware may also be required to meet applicable service requirements. Environment 206 may include an operating system, number of processors or cores, memory, virtual machines, a software stack, a database, a database configuration, etc. In a further example, environment 206 may include database software to be instantiated in target infrastructure 108. In yet another example, environment 206 may include compressed software files with configuration parameters to be instantiated in target infrastructure 108. Environment 206 may specify a particular version of software to be instantiated in target infrastructure 108. In yet another example, environment 206 may recommend hardware and/or software for use in target infrastructure 108. In this example, target infrastructure 108 may use the recommended hardware and/or software or may use hardware and/or software that includes additional features and/or performance characteristics with more recent versions than the recommended hardware and/or software.

Service requirements 204 may include a level of performance that may be required of data 112 once instantiated in target infrastructure 108. Service requirements 204 may be assigned as a parameter or may be included within model 208. Examples of service requirements include application availability, quality/reliability, application login/access, functionalities, data security and operational requirements. In an example, quality/reliability service requirements may allow a user of an application to experience the same colors, fonts, usability, interfaces etc., regardless of whether the application is running on target infrastructure 108 or source infrastructure 102. Additionally, quality/reliability service requirements may guarantee that an application runs without crashing in target infrastructure 108. Login/access service requirements may include a user expectation regarding login performance (such as an amount of time required to login to an application). In an example of a functionality service requirement, a user of a report-generating application may expect reports to be generated in the same format with equal or greater speed in target infrastructure 108 as reports generated in source infrastructure 102.

In an example of an application availability service requirement, an application available in both a mobile platform and in a browser may maintain the same level of availability and accessibility after the migration from source infrastructure 102 to target infrastructure 108. In another example, applications may maintain the same speed in target infrastructure 108 as experienced in source infrastructure 102. In a further example of a login/access service requirement, a user may use the same login/authentication procedure in target infrastructure 108 as in source infrastructure 102 (this may include the same password and/or username). In another example of a functionality service requirement, a user may experience the same application menu items in target infrastructure 108 as experienced in source infrastructure 102.

Instantiation instructions 202 may include instructions that may be configured to detect various parameters of target infrastructure 108. Instantiation instructions 202 may build and instantiate environment 206 within target infrastructure 108, build and instantiate model 208, and deliver and instantiate service requirements 204 to target infrastructure 108. Instantiation instructions 202 may include executable code, or may be data that may be used by software running in target infrastructure 108. Instantiation instructions 202 may verify the existence of database software in target infrastructure 108. If no database software is present, instantiation instructions 202 may download the correct version of database software and install the correct version based on environment 206. In another example, database software may be included in environment 206. In this example, instantiation instructions 202 may install database software in target infrastructure 108. Instantiation instructions 202 may be configured to build data models (such as model 208) and associate data identified by virtual data cores (such as virtual data core 118) in target infrastructure 108. Instantiation instructions 202 may also detect service requirements 204 and ensure that target infrastructure 108 complies with service requirements 204.

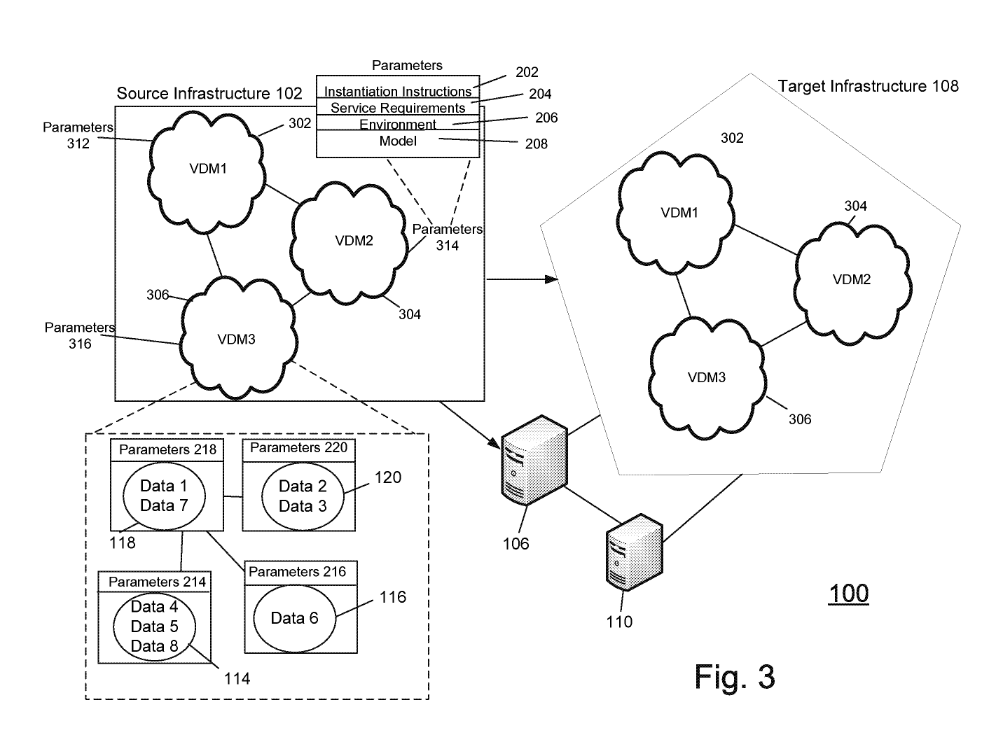

FIG. 3 depicts example system 100 of FIG. 1 illustrating additional details relating to virtual data machines, arranged in accordance with at least some embodiments described herein. Those components in FIG. 3 that are labeled identically to components of FIGS. 1 and 2 will not be described again for the purposes of clarity and brevity.

Virtual data cores 114, 116, 118 and 120 and assigned parameters 214, 216, 218 and 220 may be grouped by data migration unit 106 into one or more virtual data machines (“VDMs”) 302, 304 and 306. Parameters, including parameters 312, 314 and 316 may be assigned at the virtual data machine level. Parameters may include instantiation instructions 202, service requirements 204, environment 206 and model 208. In one example, parameters assigned at the virtual data machine level may be given precedence over parameters assigned at the virtual data core level when a conflict arises. In another example, parameters assigned at the virtual data core level may be given precedence over parameters assigned at the virtual data machine level when a conflict arises. Data migration unit 106 may facilitate migration of data 112 based on virtual data machines 302, 304 and 306 from source infrastructure 102 to target infrastructure 108. In an example, data migration unit 106 may facilitate migration of data 112 by instructing computing devices of source infrastructure 102 to migrate data based on virtual data machines 302, 304 and 306 to target infrastructure 108. In another example, data migration unit 106 may facilitate migration of data 112 based on virtual data machines 302, 304 and 306 through one or more intermediary computing devices 110.

Among other possible features, a system in accordance with the disclosure may facilitate transfer of computing services from one computing infrastructure to another. Data may be grouped or packaged independently of any particular infrastructure to allow for easy migration of data, irrespective of particular platforms and/or hardware. The system may configure computing resources in a destination infrastructure to ensure that applicable service level requirements are met. The system may ensure that service requirements are maintained and met when migrating applications and/or services between two different computing infrastructures. Migration may be implemented with limited manual work by a user. A user may migrate data from one infrastructure to another while maintaining operational requirements such as security, access control, trust and privacy, data transparency, scalability, concurrency, security and performance, manageability, etc.

In an example, a user of system 100 may wish to migrate data 112 from source infrastructure 102 to target infrastructure 108. Data 112 may include a SQL database and file directories. The SQL database may include two tables with employment records. The first table may include general employee records and the second table may include confidential employee records. Each record in the two tables may be associated with a PDF of each employee's résumé which may be stored in a separate file directory. In the example, after migration to target infrastructure 108, the user may desire:

1. Fast access to general employee records and confidential employee records.
2. Additional security measures for the confidential employee records.
3. A different set of security access for the employee résumés.

The user may be willing to accept slower access to employee résumés relative to the general employee records and confidential employee records. System 100 may package the first table as a first virtual data core, the second table as a second virtual data core and the file directory (including employee résumés) as a third virtual data core. Each virtual data core may then be assigned individualized parameters, including instantiation instructions 202, service requirements 204, environment 206 and/or model 208. The three virtual data cores may be packaged as a virtual data machine which is hardware independent.

In target infrastructure 108, the instantiation instructions may create the correct environment, create the appropriate data models, move the data and provision the hardware, software and other resources according to the performance and security parameters (service requirements) assigned to each virtual data core. As described, data 112 may be migrated to target infrastructure 108.

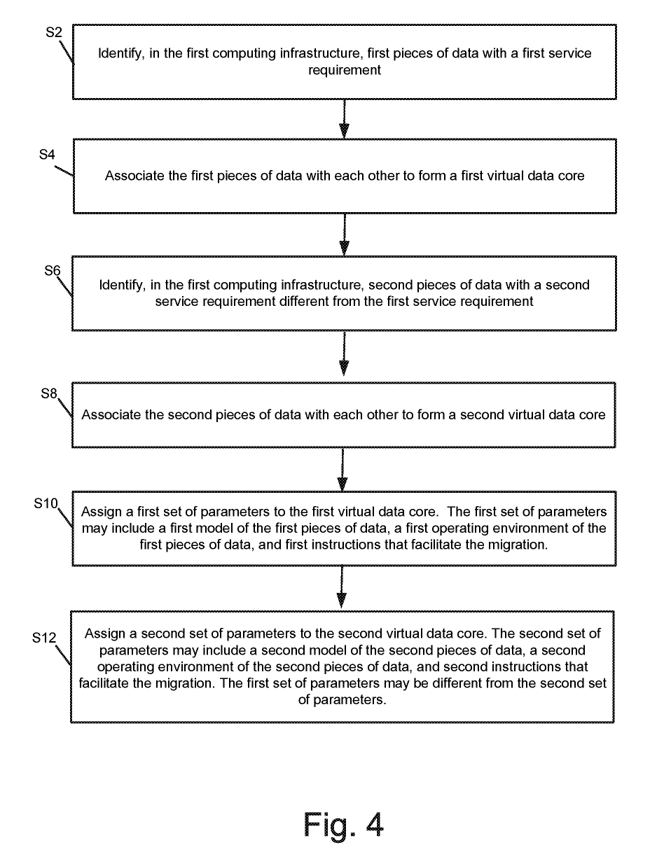

FIG. 4 depicts a flow diagram for an example process for implementing an infrastructure migration tool, arranged in accordance with at least some embodiments described herein. In some examples, the process in FIG. 4 could be implemented using system 100 discussed above and could be used to facilitate migration of data between a source computing infrastructure and a target computing infrastructure. An example process may include one or more operations, actions, or functions as illustrated by one or more of blocks S2, S4, S6, S8, S10 and/or S12. Although illustrated as discrete blocks, various blocks may be divided into additional blocks, combined into fewer blocks, or eliminated, depending on the desired implementation. The process in FIG. 4 may be used by a system that includes a migration tool, such as data migration unit 106. In some embodiments, additional blocks representing further other operations, actions, or functions may be provided. The data migration unit may be configured in communication with one or more computing infrastructures.

Processing may begin at block S2, “Identify, in the first computing infrastructure, first pieces of data with a first service requirement.” At block S2, first pieces of data with a first service requirement may be identified in the first computing infrastructure.

Processing may continue from block S2 to block S4, “Associate the first pieces of data with each other to form a first virtual data core.” At block S4, the first pieces of data may be associated with each other to form a first virtual data core. In an example, a first pointer to the first pieces of data may be stored in the first virtual data core.

Processing may continue from block S4 to block S6, “Identify, in the first computing infrastructure, second pieces of data with a second service requirement different from the first service requirement.” At block S6, second pieces of data with a second service requirement different from the first service requirement may be identified in the first computing infrastructure.

Processing may continue from block S6 to block S8, “Associate the second pieces of data with each other to form a second virtual data core.” At block S8, the second pieces of data may be associated with each other to form a second virtual data core. In an example, a second pointer to the second pieces of data may be stored in the second virtual data core. In a further example, a connection may be identified between the first pieces of data associated in the first virtual data core and the second pieces of data associated in the second virtual data core.

Processing may continue from block S8 to block S10, “Assign a first set of parameters to the first virtual data core. The first set of parameters may include a first model of the first pieces of data, a first operating environment of the first pieces of data, and first instructions that facilitate the migration.” At block S10, a first set of parameters may be assigned to the first virtual data core. The first set of parameters may include a first model of the first pieces of data, a first operating environment of the first pieces of data, and first instructions that facilitate the migration. In an example, the first set of parameters may include additional service requirements different from the first service requirements.

Processing may continue from block S10 to block S12, “Assign a second set of parameters to the second virtual data core. The second set of parameters may include a second model of the second pieces of data, a second operating environment of the second pieces of data, and second instructions that facilitate the migration. The first set of parameters may be different from the second set of parameters.” At block S12, a second set of parameters may be assigned to the second virtual data core. The second set of parameters may include a second model of the second pieces of data, a second operating environment of the second pieces of data, and second instructions that facilitate the migration. The first set of parameters may be different from the second set of parameters. In an example, the second set of parameters may include additional service requirements different from the second service requirements. In another example, the first and second pieces of data may be migrated from the source computing infrastructure to the target computing infrastructure, based on the first virtual data core and the second virtual data core. In a further example, migrating the first and second piece of data may include instructing computing devices of the source computing infrastructure to migrate the first and second pieces of data from the source computing infrastructure to the target computing infrastructure.

In a further example, the first virtual data core and the first set of parameters may be grouped with the second virtual data core and the second set of parameters into a virtual data machine. The first and second pieces of data from the first computing infrastructure may be migrated from the first computing infrastructure to the second computing infrastructure based on the virtual data machine. In another example, a third set of parameters may be assigned to the virtual data machine. The third set of parameters may include a third model of data in the virtual data machine, a third operating environment of the virtual data machine and third instructions that facilitate the migration. In a further example, a precedence may be assigned to the third set of parameters over the first set of parameters and over the second set of parameters. In another example, the first and second operating environment may specify software and/or hardware required in the target computing infrastructure.

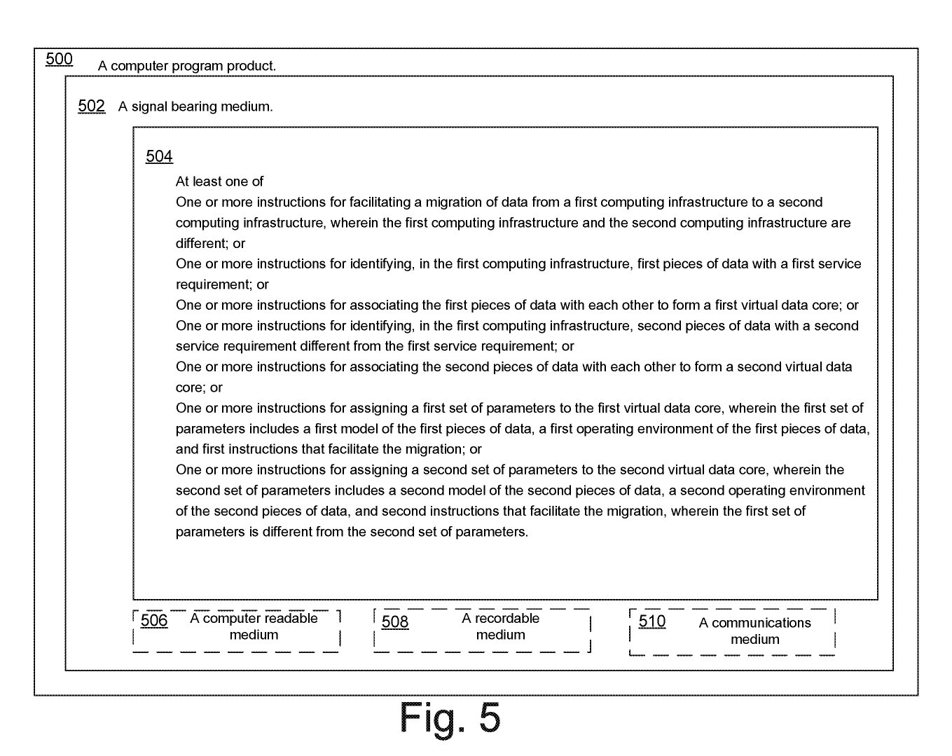

FIG. 5 illustrates an example computer program product 500 that can be utilized to implement an infrastructure migration tool, arranged in accordance with at least some embodiments described herein. Program product 500 may include a signal bearing medium 502. Signal bearing medium 502 may include one or more instructions 504 that, in response to execution by, for example, a processor may provide the features described above with respect to FIGS. 1-4. Thus, for example, referring to system 100, data migration unit 106 may undertake one or more of the blocks shown in FIG. 5 in response to instructions 504 conveyed to system 100 by medium 502.

In some implementations, signal bearing medium 502 may encompass a non-transitory computer-readable medium 506, such as, but not limited to, a hard disk drive, a Compact Disc (CD), a Digital Video Disk (DVD), a digital tape, memory, etc. In some implementations, signal bearing medium 502 may encompass a recordable medium 508, such as, but not limited to, memory, read/write (R/W) CDs, R/W DVDs, etc. In some implementations, signal bearing medium 502 may encompass a communications medium 510, such as, but not limited to, a digital and/or an analog communication medium (e.g., a fiber optic cable, a waveguide, a wired communications link, a wireless communication link, etc.). Thus, for example, program product 500 may be conveyed to one or more modules of the system 100 by an RF signal bearing medium 502, where the signal bearing medium 502 is conveyed by a wireless communications medium 510 (e.g., a wireless communications medium conforming with the IEEE 802.11 standard).

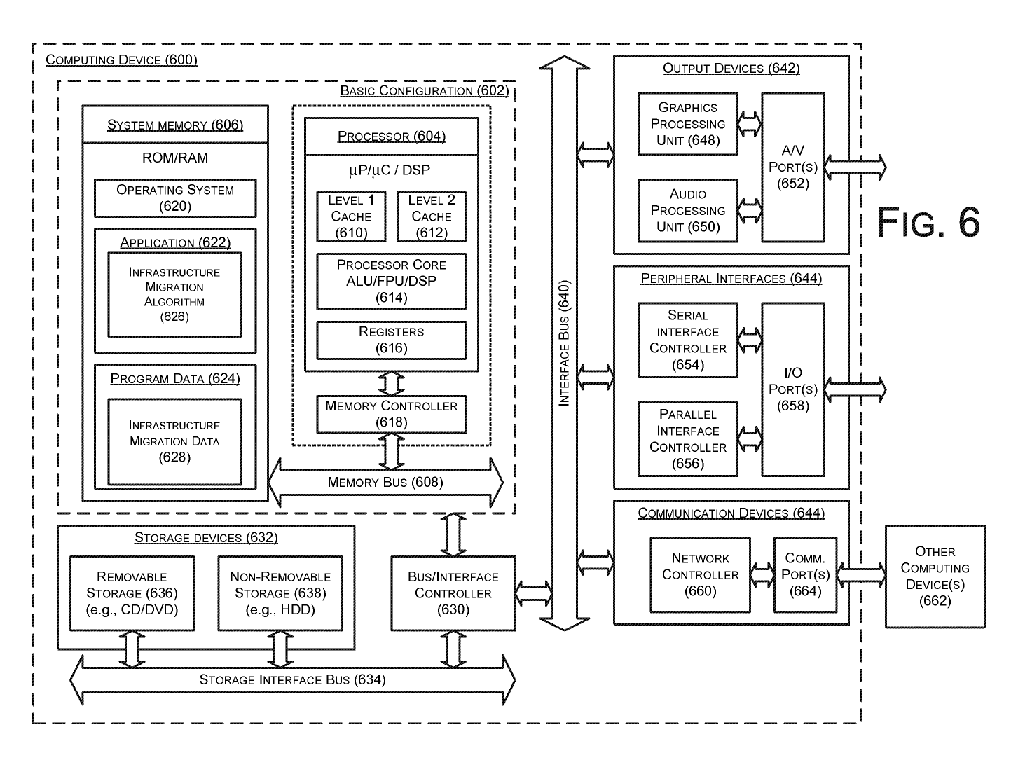

FIG. 6 is a block diagram illustrating an example computing device 600 that is arranged to implement an infrastructure migration tool, arranged in accordance with at least some embodiments described herein. In a very basic configuration 602, computing device 600 typically includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, one or more programmable circuits 666 and program data 624. Application 622 may include an infrastructure migration algorithm 626 that is arranged to perform the operations as described herein including those described with respect to system 100 of FIGS. 1-5. Program data 624 may include infrastructure migration data 628 that may be useful to implement an infrastructure migration tool as is described herein. In some embodiments, application 622 may be arranged to operate with program data 624 on operating system 620 such that an infrastructure migration tool may be provided. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 600. For example, memory 104 from FIGS. 1-2 may be examples of computer storage media. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to facilitate a migration of data from a first computing infrastructure to a second computing infrastructure, wherein the first computing infrastructure and the second computing infrastructure are different, the method comprising, by a data migration unit:
identifying, in the first computing infrastructure, first pieces of data, wherein the first pieces of data share a first service requirement;
associating the first pieces of data with each other to form a first virtual data core;
identifying, in the first computing infrastructure, second pieces of data, wherein the second pieces of data share a second service requirement different from the first service requirement;
associating the second pieces of data with each other to form a second virtual data core;
assigning a first set of parameters to the first virtual data core, wherein the first set of parameters includes a first model of the first pieces of data, a first operating environment of the first pieces of data, and first instructions that facilitate the migration; and
assigning a second set of parameters to the second virtual data core, wherein the second set of parameters includes a second model of the second pieces of data, a second operating environment of the second pieces of data, and second instructions that facilitate the migration;
wherein the first set of parameters is different from the second set of parameters.

2. The method of claim 1, further comprising:
storing a first pointer to the first pieces of data in the first virtual data core; and
storing a second pointer to the second pieces of data in the second virtual data core.

3. The method of claim 1, further comprising migrating the first and second pieces of data, based on the first virtual data core and the second virtual data core, from the first computing infrastructure to the second computing infrastructure.

4. The method of claim 3, wherein migrating the first and second piece of data includes instructing computing devices of the first computing infrastructure to migrate the first and second pieces of data from the first computing infrastructure to the second computing infrastructure.

5. The method of claim 1, wherein the first and second set of parameters include additional service requirements different from the first and second service requirements.

6. The method of claim 1, further comprising:
grouping the first virtual data core and the first set of parameters with the second virtual data core and the second set of parameters into a virtual data machine; and
migrating the first and second pieces of data from the first computing infrastructure to the second computing infrastructure based on the virtual data machine.

7. The method of claim 6, further comprising:
assigning a third set of parameters to the virtual data machine, wherein the third set of parameters includes a third model of data in the virtual data machine, a third operating environment of the virtual data machine, and third instructions that facilitate the migration.

8. The method of claim 7, further comprising assigning a precedence to the third set of parameters over the first set of parameters and over the second set of parameters.

9. The method of claim 1, further comprising:
identifying a connection between the first pieces of data associated in the first virtual data core and the second pieces of data associated in the second virtual data core.

10. A data migration unit configured to facilitate the migration of data from a first computing infrastructure to a second computing infrastructure, wherein the first computing infrastructure and the second computing infrastructure are different, the data migration unit comprising:
a memory; and
a processor configured to be in communication with the memory, the processor configured to:
identify, in the first computing infrastructure, first pieces of data, wherein the first pieces of data share a first service requirement;
associate the first pieces of data with each other to form a first virtual data core;
identify, in the first computing infrastructure, second pieces of data, wherein the second pieces of data share a second service requirement different from the first service requirement;
associate the second pieces of data with each other to form a second virtual data core;
store the first and second virtual data cores in the memory;
assign a first set of parameters to the first virtual data core, wherein the first set of parameters includes a first model of the first piece of data, a first operating environment of the first piece of data, and first instructions that facilitate the migration;
store the first set of parameters in the memory assigned to the first virtual data core;
assign a second set of parameters to the second virtual data core, wherein the second set of parameters includes a second model of the second piece of data, a second operating environment of the second piece of data, and second instructions that facilitate the migration; and
store the second set of parameters in the memory assigned to the second virtual data core;
wherein the first set of parameters is different from the second set of parameters.

11. The data migration unit of claim 10, wherein the processor is further configured to:
store a first pointer to the first pieces of data in the first virtual data core; and
store a second pointer to the second pieces of data in the second virtual data core.

12. The data migration unit of claim 10, wherein the processor is further configured to migrate the first and second pieces of data, based on the first virtual data core and the second virtual data core, from the first computing infrastructure to the second computing infrastructure.

13. The data migration unit of claim 12, wherein the processor is further configured to migrate the first and second pieces of data by instruction to computing devices of the first computing infrastructure to migrate the first and second pieces of data from the first computing infrastructure to the second computing infrastructure.

14. The data migration unit of claim 10, wherein the first and second sets of parameters include additional service requirements different from the first and second service requirements.

15. The data migration unit of claim 10, wherein the processor is further configured to:
group the first virtual data core and the first set of parameters with the second virtual data core and the second set of parameters into a virtual data machine; and
migrate the first and second pieces of data from the first computing infrastructure to the second computing infrastructure based on the virtual data machine.

16. The data migration unit of claim 15, wherein the processor is further configured to:
assign a third set of parameters to the virtual data machine, wherein the third set of parameters includes a third model of data in the virtual data machine, a third operating environment of the virtual data machine, and third instructions that facilitate the migration.

17. The data migration unit of claim 16, wherein the processor is further configured to assign a precedence to the third set of parameters over the first set of parameters and over the second set of parameters.

18. The data migration unit of claim 10, wherein the first and the second operating environment specifies software and/or hardware required in the second computing infrastructure.

19. A non-transitory computer readable medium effective to facilitate a migration of data from a first computing infrastructure to a second computing infrastructure, wherein the first computing infrastructure and the second computing infrastructure are different, the computer readable medium comprising:
a first virtual data core that includes first pointers to first pieces of data, wherein the first pieces of data share a first service requirement, and wherein the first virtual data core is assigned a first set of parameters, the first set of parameters including a first model of the first pieces of data, a first operating environment of the first pieces of data, and first instructions that facilitate the migration; and
a second virtual data core that includes second pointers to second pieces of data, wherein the second pieces of data share a second service requirement, and wherein the second virtual data core is assigned a second set of parameters, the second set of parameters including a second model of the second pieces of data, a second operating environment of the second pieces of data, and second instructions that facilitate the migration;
wherein the first set of parameters is different from the second set of parameters.

20. The non-transitory computer readable medium of claim 19, further comprising:
a connection between the first pieces of data associated in the first virtual data core and the second pieces of data associated in the second virtual data core.
